(19) United States
(12) Patent Application Publication
(10) Pub. No.: US 2009/0278783 A1
(43) Pub. Date: Nov. 12, 2009

(54) LIQUID CRYSTAL DISPLAY WITH SLIM BORDERS AND DRIVING METHOD THEREOF

(75) Inventors: Yu-hsin Ting, Hsin-Chu City (TW); Chung-lin Fu, Hsin-Chu City (TW); Chun-yen Liu, Hsin-Chu City (TW)

Correspondence Address: KIRTON AND MCCONKIE, 60 EAST SOUTH TEMPLE,, SUITE 1800, SALT LAKE CITY, UT, 84111, US

(73) Assignee: AU OPTRONICS CORP., Hsin-Chu (TW)

(21) Appl. No.: 12/348,490

(22) Filed: Jan. 5, 2009

(30) Foreign Application Priority Data
May 6, 2008 (TW) 097116717

(51) Int. Cl. G09G 3/36

(52) U.S. Cl. 345/100

(57) ABSTRACT

A display device includes a substrate, a display area, an ASIC disposed by a first edge of the display area for generating a number of P data voltage signals, a first shift register having a plurality of first shift register units disposed by a second edge of the display area, a second shift register having a plurality of second shift register units disposed by a third edge of the display area, a plurality of first switch unit and a plurality of second units. The first switch units sequentially outputs the first through the

$$\frac{P}{2} th$$

data voltage signals to the display area in response to first control signal from the first shift register units, simultaneously, the second switch units sequentially outputs the

$$( \frac{P}{2} + 1 ) th$$

through the Pth data voltage signals to the display area in response to second control signal from the second shift register units.

### BACKGROUND OF THE INVENTION

1. Field of the Invention

The present invention relates to a liquid crystal display device, and more specifically, to a liquid crystal display device with slim borders.

2. Description of Prior Art

With a rapid development of monitor types, novel and colorful monitors with high resolution, e.g., liquid crystal displays (LCDs), are indispensable components used in various electronic products such as monitors for notebook computers, personal digital assistants (PDAs), digital cameras, and projectors. The demands for the novelty and colorful monitors have increased tremendously. A Low Temperature Poly-Silicon Liquid Crystal Display (LTPS LCD) panel, on account of high resolution demands, is widely applied to various electronic devices.

Referring to FIG. 1 showing a schematic diagram of a conventional liquid crystal display (LCD) device 10, the LCD device 10 comprises a substrate 12, an application-specific integrated circuit (ASIC) 14, a source drivers 16, a gate driver 18, a printed circuit board (PCB) 22, and a display area 20. The source driver 16, the gate driver 18, and the display area 20 are all mounted on the substrate 12. The ASIC 14 is mounted on the PCB 22 and is electrically coupled to the source driver 16. The display area 20, e.g. an LCD panel, having a number of m×n pixels is coupled to the gate driver 18 and the source driver 16 via a number of m scan lines GL₁-GLₘ, and a number of n data lines DL₁-DLₙ, respectively.

Referring to FIG. 1 and FIG. 2 showing a timing diagram of the data voltage signal from the ASIC and outputs of shift register units in the source driver 16, the ASIC 14 is coupled to the source driver 16 by means of a number of P transmission lines SL₁-SL_{P}. The source driver 16 comprises a number of n switch units 162 and shift register units HSR₁˜HSR_{n/p}, and each shift register unit HSR₁˜HSR_{n/p} corresponds to a number of P switch units 162. Each of the switch units 162 corresponds to one of the data lines, and is controlled by a control signal generated by one of shift register units HSR₁˜HSR_{n/p} to be turned on/off. When the gate driver 18 generates a plurality scan voltage signal to the display area 20, the switch units 162 according to the control signals provided by the shift register unit HSR₁˜HSR_{n/P} determine whether the data voltage signal from the ASIC 14 enters the DL₁-DLₙ through the transmission lines SL₁-SL_{P} or not. Each of the shift register unit HSR₁˜HSR_{n/P} drives a number of P switch units. The shift register unit HSR₁ sends a control signal to turn on the switch unit 162, which makes the data voltage signals via a number of P transmission lines SL₁-SL_{P} in turn enter data lines DL₁-DL_{P} respectively. Then, the shift register unit HSR₂ sends a control signal to turn on its corresponding switch unit 162, which makes the data voltage signals via a number of P transmission lines SL₁-SL_{P} in turn enter data lines DL_{P+1}-DL_{2P}, respectively The process continues till the shift register unit HSR_{n/P} sends a control signal to switch on its switch unit 162 so that the data voltage signals via a number of P transmission lines SL₁-SL_{P} in turn enter data lines DL_{n*P+1}-DL_{n,} respectively.

For high-resolution LCD panels, more and more transmission lines are needed. The traditional layout for the LCD device, as shown in FIG. 1, is that the source driver 16, the gate driver 18, and the ASIC 14 are disposed by a first edge 201, a second edge 202, and a third edge 203 of the display area 20, respectively. A number of transmission lines SL₁-SL_{P} increases as the required resolution of the LCD panel increases, and thus broadens width W1 to occupy more area of the substrate 12. This results in an uneven sense of sight since the transmission lines SL₁-SL_{P} are all disposed on a side of the LCD device 10. Therefore, it is a task for the designers develop a liquid crystal display device with slim borders.

### SUMMARY OF THE INVENTION

It is therefore an object of the present invention to provide a liquid crystal display device with slim borders and a method for driving the present invention LCD device. Briefly summarized, a display device comprises a substrate, a display area, an application-specific integrated circuit (ASIC), a first shift register having a plurality of first shift register units, a second shift register having a plurality of second shift register units, a plurality of first switch unit and a plurality of second units. The display area disposed on the substrate is for displaying an image comprises a first edge, a second edge, a third edge. The first edge is perpendicular to the second and the third edges. The second edge is opposite to the third edge. The ASIC disposed by the first edge of the display area is used for generating a number of P data voltage signals. The first shift register comprises a plurality of first shift register units disposed by the second edge of the display area, and each first shift register unit is for generating a first control signal. The plurality of first switch unit are used for sequentially outputting a first through a

$$\frac{P}{2} th$$

data voltage signals to the display area in response to the first control signal from the first shift register units, simultaneously. The second shift register comprises a plurality of second shift register units disposed by the third edge of the display area, and each second shift register unit is for generating a second control signal. The plurality of second switch units are used for sequentially outputting a

$$( \frac{P}{2} + 1 ) th$$

through a Pth data voltage signals to the display area in response to the second control signal from the second shift register units.

According to the present invention, a method of driving a display device is provided. The display device comprises a display area, a first shift register having a plurality of first shift register units, a second shift register having a plurality of second shift register units, a plurality of first switch unit and a plurality of second switch units. The display area comprises a first edge, a second edge, and a third edge. The first edge is perpendicular to the second and the third edges. The second edge is opposite to the third edge. Each first shift register unit is coupled to one of the first switch unit and disposed by the second edge of the display area. Each second shift register unit is coupled to one of the second switch unit and disposed by the third edge of the display area. The method comprises the steps of providing an application-specific integrated circuit (ASIC) to generate a number of P data voltage signals, and sequentially outputting with the plurality of first switch units a first through a

$$\frac{P}{2} th$$

data voltage signals to the display area, and sequentially outputting with the plurality of second switch units a

$$( \frac{P}{2} + 1 ) th$$

through a Pth data voltage signals to the display area upon receiving control signals from the plurality of first shift register units and the plurality of second shift register units.

These and other objectives of the present invention will become apparent to those of ordinary skill in the art after reading the following detailed description of the preferred embodiment that is illustrated in the various figures and drawings.

### BRIEF DESCRIPTION OF THE DRAWINGS

FIG. 1 shows a schematic diagram of a conventional liquid crystal display (LCD) device.

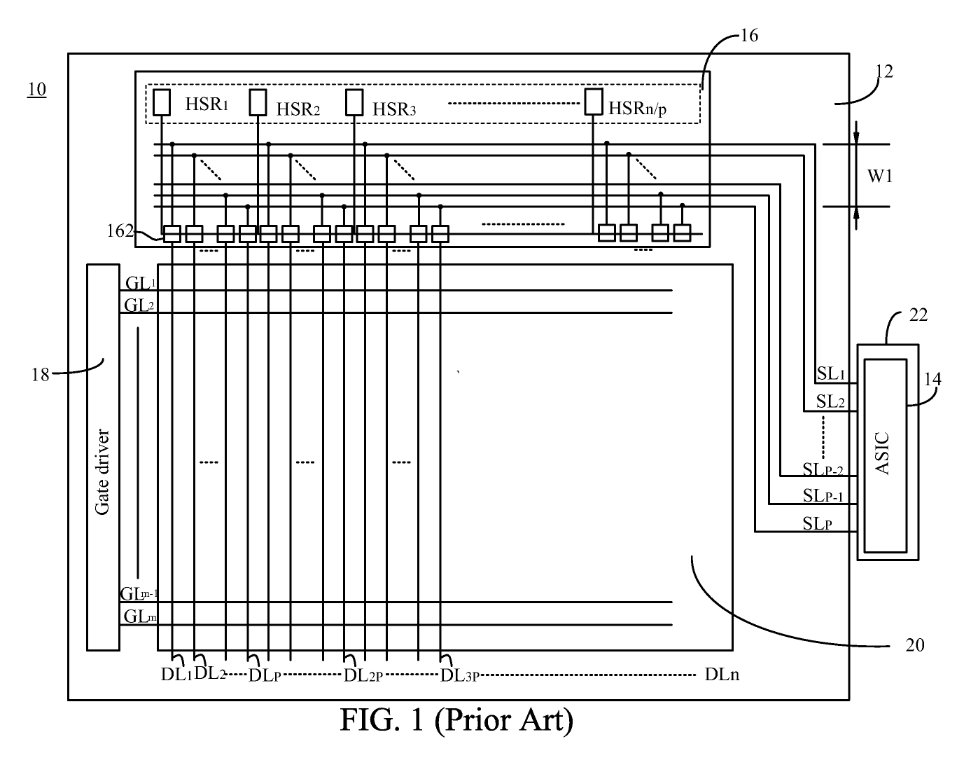

FIG. 2 shows a timing diagram of the data voltage signal from the ASIC and outputs of shift register units in the source driver.

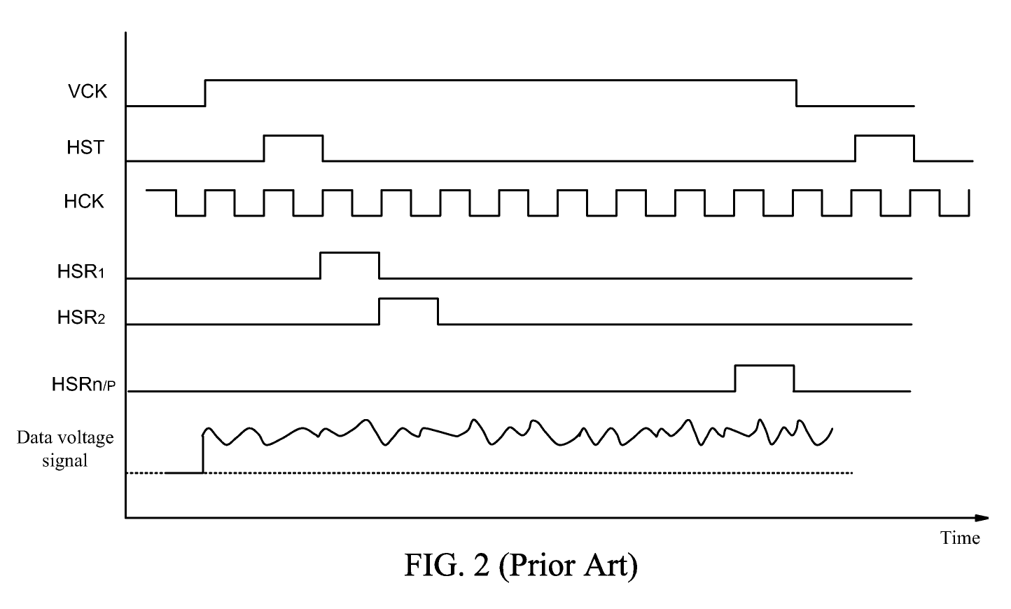

FIG. 3 shows a schematic diagram of a liquid crystal display (LCD) device according to a preferred embodiment of the present invention.

FIG. 4 is a timing diagram of the data voltage signal from the ASIC and outputs of shift register units in the source drivers.

FIG. 5 is a flowchart of the driving method of the present invention.

### DETAILED DESCRIPTION OF THE PREFERRED EMBODIMENTS

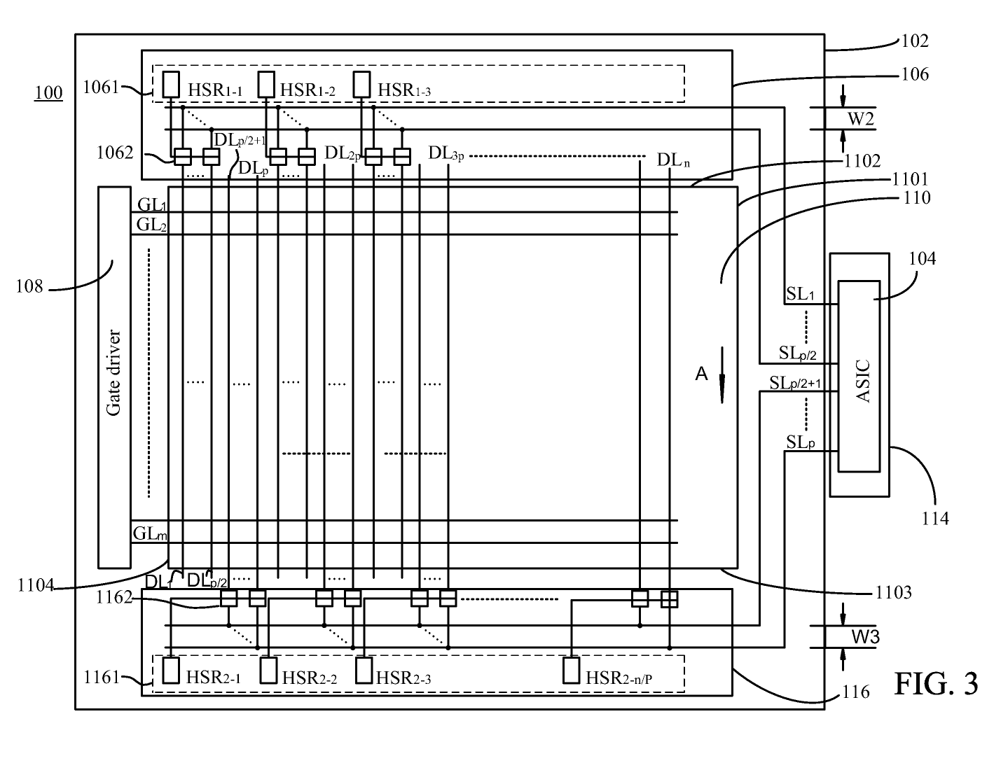

Referring to FIG. 3 showing a schematic diagram of a liquid crystal display (LCD) device 100 according to a preferred embodiment of the present invention, the LCD device 100 comprises a substrate 102, an application-specific integrated circuit (ASIC) 104, source drivers 106 and 116, a gate driver 108, a printed circuit board 114, and a display area 110. The ASIC 104, the source drivers 106 and 116, and the gate driver 108 are all mounted on a flexible printed circuit board (FPC) by using Chip on film (COF), or mounted on the glass substrate 102 and electrically connected to the PCB 114 via the FPC by using Chip on glass (COG). The ASIC 104 is mounted on the PCB 114 and is electrically coupled to the source drivers 106 and 116. The display area 110, e.g. an LCD panel, having a number of m×n pixels is coupled to the gate driver 108 and the source drivers 106 and 116 via a number of m scan lines GL₁-GLₘ, and a number of n data lines DL₁-DLₙ, respectively. The ASIC 104 is disposed by a first edge 1101 of the display area 110, and is coupled to the source drivers 106 and 116 by means of a number of

$$\frac{P}{2}$$

transmission lines

$${SL}_{1} - {SL}_{\frac{P}{2}} ,$$

and a number of

$$\frac{P}{2}$$

transmission lines

$${SL}_{\frac{P}{2} + 1} - {SL}_{P} ,$$

respectively. The source driver 106 disposed by a second edge 1102 of the display area 110, comprises a first shift register 1061 and a number of

$$\frac{n}{2}$$

switch units 1062. The first shift register 1061 comprises shift register units HSR₁₋₁˜HSR_{1-n/p}, and each shift register unit HSR₁₋₁˜HSR_{1-n/p} corresponds to a number of

$$\frac{P}{2}$$

switch units 1062. The source driver 116 disposed by a third edge 1103 of the display area 110, comprises a second shift register 1161 and a number of

$$\frac{n}{2}$$

switch units 1162. The second shift register 1161 comprises shift register units HSR₂₋₁˜HSR_{2-n/p}, and each shift register unit HSR₂₋₁˜HSR_{2-n/p} corresponds to a number of

$$\frac{P}{2}$$

switch units 1162. Each of the switch units 1062, 1162 corresponds to one of the data lines, and is controlled by a control signal generated by one of shift register units HSR₁₋₁˜HSR_{1-n/p} and HSR₂₋₁˜HSR_{2-n/p} to be turned on/off. The gate driver 108 disposed by a fourth edge of the display area 1104 is used for generating a plurality scan voltage signal to the display area 110. In this embodiment, since the source drivers 106, 116 are disposed by the edges 1102 and 1103, and are coupled to ASIC 104 via transmission lines

$${SL}_{1} - {SL}_{\frac{P}{2}} , {SL}_{\frac{P}{2} + 1} - {SL}_{P} ,$$

respectively, the number of the transmission lines is evenly distributed to two borders of the LCD device 100. In other words, the widths W2 and W3 of the LCD device 100 are half that of the conventional LCD device 10. Therefore, widths of the both sides of the display area 110 are narrower and more even, which gives a fairer appearance for the LCD device 100.

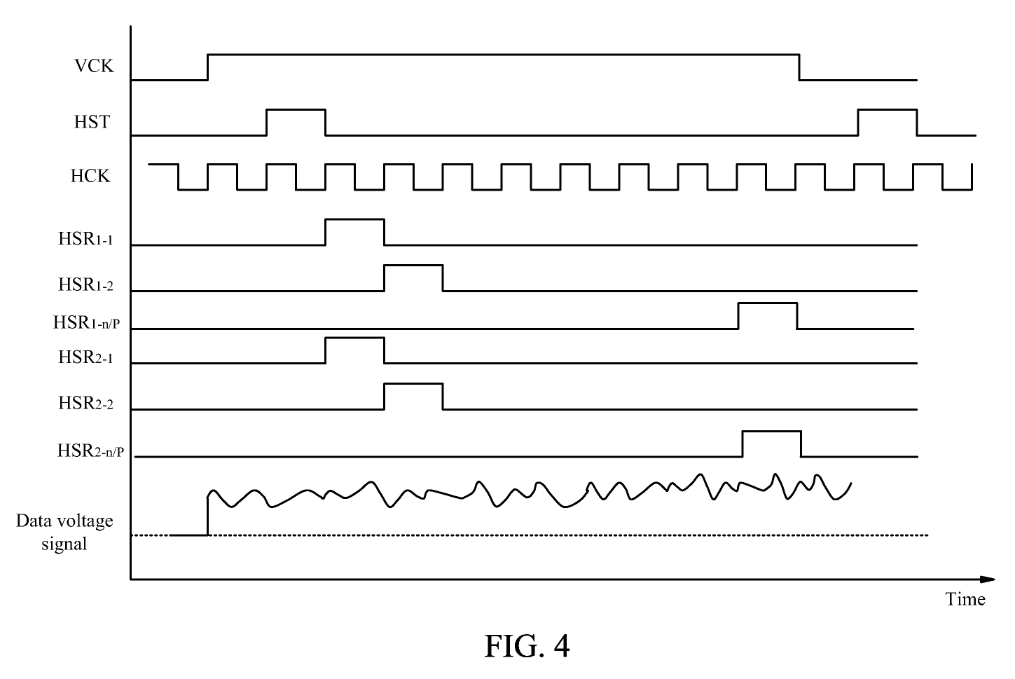

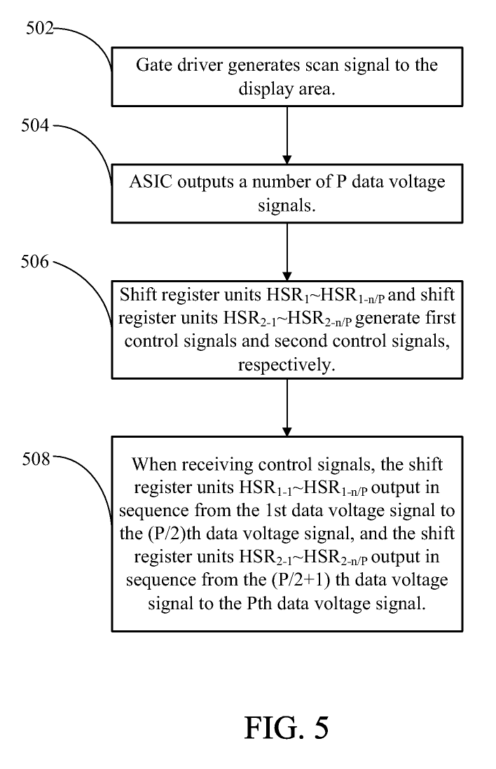

Please refer to FIG. 3, FIG. 4 and FIG. 5. FIG. 4 is a timing diagram of the data voltage signal from the ASIC 104 and outputs of shift register units in the source drivers 106 and 116. FIG. 5 is a flowchart of the driving method of the present invention. In process of a display, i.e. during which a scan signal VCK is at high voltage level, the gate driver 108 generates the scan signal VCK into the display area 110 (Step 502). After then, the ASIC 104 outputs a number of P data voltage signals (Step 504). Next, the first shift register units HSR₁˜HSR_{1-n/P} and the second shift register units HSR₂₋₁˜HSR_{2-n/P} generate first control signals and a second control signals, respectively (Step 506). When the display area 110 receives the scan signal VCK, switch units 1062 and 1162 determine whether the data voltage signal from the ASIC 114 enters the transmission lines

$${SL}_{1} - {SL}_{\frac{P}{2}} and {SL}_{\frac{P}{2} + 1} - {SL}_{P}$$

or not, according to the control signals provided by the shift register units HSR₁˜HSR_{1-n/P} and HSR₂₋₁˜HSR_{2-n/P,} respectively (Step 508). Firstly, the shift register unit HSR₁₋₁ sends a control signal to switch on its corresponding switch unit 1062, which makes the data voltage signals via a number of

$$\frac{P}{2}$$

transmission lines

$${SL}_{1} - {SL}_{\frac{P}{2}}$$

in turn enters data lines

$${DL}_{1} - {DL}_{\frac{P}{2}} ,$$

respectively. At the same time, the shift register unit HSR₂₋₁ sends a control signal to switch on its corresponding switch unit 1162, which allows the data voltage signals via a number of

$$\frac{P}{2}$$

transmission lines

$${SL}_{\frac{P}{2} + 1} - {SL}_{P}$$

in turn enters data lines

$${DL}_{\frac{P}{2} + 1} - {DL}_{P} ,$$

respectively. The process continues till the shift register unit HSR_{n/P} sends a control signal to switch on its corresponding switch unit 1162 so that the data voltage signals via a number of

$$\frac{P}{2}$$

transmission lines

$${SL}_{1} - {SL}_{\frac{P}{2}}$$

in turn enter data lines

$${DL}_{\frac{nP}{2} + 1} - {DL}_{n} ,$$

respectively.

Please note, the ASIC 114 delivers a number of P data voltage signals into the transmission lines SL₁-SL_{P} in order (as indicated by an arrow A in FIG. 3). Upon receiving the control signals from the shift register units HSR₁₋₁ and HSR₂₋₁, the switch unit 1062 and the switch unit 1162 are turned on and then the data voltage signals enter the data lines

$${DL}_{1} - {DL}_{\frac{P}{2}} and {DL}_{\frac{P}{2} + 1} - {DL}_{P} ,$$

respectively. That is, in this embodiment, it is not required to adjust the timing of the number of P data voltage signals outputted by the ASIC 114, but to keep outputting the data voltage signals in order from 1 to P to the switch units 1062 and 1162. In response to control signals, the shift register units HSR₁₋₁˜HSR_{1-n/P} are outputted in sequence from the 1st data voltage signal to the

$$\frac{P}{2} th$$

data voltage signal, and the shift register units HSR₂₋₁˜HSR_{2-n/P} are outputted in sequence from the

$$( \frac{P}{2} + 1 ) th$$

data voltage signal to the Pth data voltage signal.

In another embodiment of the present invention, the transmission lines can also be arranged to divide into two groups: the odds and the evens. That is, after receiving the control signals from the shift register units HSR₁₋₁ and HSR₂₋₁, the switch unit 1062 are switched on and then the data voltage signals enter the data lines DL₁, DL₃ . . . DL₂ₙ₊₁, while the switch unit 1162 is switched on and then the data voltage signals enter the data lines DL₂, DL₄ . . . DL₂ₙ.

Because the ASIC 104 is connected with the transmission lines

$${SL}_{1} - {SL}_{\frac{P}{2}} and {SL}_{\frac{P}{2} + 1} - {SL}_{P} ,$$

respectively, and each transmission line is used to drive pixels arranged in a column in turn, the ASIC 104 can send in turn a number of P data voltage signals in the direction indicated by the arrow A, without additional adjustment in the order of sending a number of P data voltage signals. It is therefore not necessary in the design of circuit to make additional timing adjustment for the output order of the ASIC 104.

Compared to the prior art, the present inventive LCD device comprises two source drivers 106 and 116, which are disposed by the two edges 1102 and 1103 of the display area 110, respectively. Also, the two source drivers 106 and 116 are connected with the ASIC 104 via the transmission lines

$${SL}_{1} - {SL}_{\frac{P}{2}} and {SL}_{\frac{P}{2} + 1} - {SL}_{P} ,$$

respectively. Because the number of the transmission lines by the edges of the display area 110 is halved, widths W2 and W3 of the present embodiment are also halved as width W1 of the LCD device according to prior art. As a result, in the LCD device of the present invention, widths of both sides of the display area 110 are narrower and more even, which gives a fairer appearance. Besides, the ASIC 104 remains to output the data voltage signals in order of 1 to P, which requires no adjustment in its output timing; so rearrangement of circuit design in the ASIC is not needed.

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the present invention.

What is claimed is:

1. A display device comprising:
a substrate;
a display area disposed on the substrate for display an image, comprising a first edge, a second edge, a third edge, the first edge being perpendicular to the second and the third edges, the second edge being opposite to the third edge;
an application-specific integrated circuit (ASIC) disposed by the first edge of the display area for generating a number of P data voltage signals;
a first shift register comprising a plurality of first shift register units disposed by the second edge of the display area, each first shift register unit for generating a first control signal;
a plurality of first switch unit for sequentially outputting a first through a
$$\frac{P}{2} th$$
data voltage signals to the display area in response to the first control signal from the first shift register units, simultaneously;
a second shift register comprising a plurality of second shift register units disposed by the third edge of the display area, each second shift register unit for generating a second control signal; and
a plurality of second switch units for sequentially outputting a
$$( \frac{P}{2} + 1 ) th$$
through a Pth data voltage signals to the display area in response to the second control signal from the second shift register units.

2. The display device of claim 1, further comprising a gate driver disposed by a fourth edge of the display area for generating a plurality of scan signals to the display area, the fourth edge being opposite to the first edge.

3. The display device of claim 1 further comprising a first source driver, wherein the first shift register and the plurality of first switch units are integrated within the first source.

4. The display device of claim 1 further comprising a second source driver, wherein the second shift register and the plurality of second switch units are integrated within the second source.

5. The display device of claim 1, wherein the ASIC is used for sequentially outputting the first through the Pth data voltage signals.

6. The display device of claim 1, wherein the display area is a liquid crystal display panel.

7. The display device of claim 1, wherein the ASIC is mounted on the substrate by using Chip on film (COF) approach or by using Chip on glass (COG) approach.

8. A method of driving a display device, the display device comprising a display area, a first shift register having a plurality of first shift register units, a second shift register having a plurality of second shift register units, a plurality of first switch unit and a plurality of second switch units, the display area comprising a first edge, a second edge, a third edge, the first edge being perpendicular to the second and the third edges, the second edge being opposite to the third edge, each first shift register unit coupled to one of the first switch unit and disposed by the second edge of the display area, each second shift register unit coupled to one of the second switch unit and disposed by the third edge of the display area, the method comprising:
providing an application-specific integrated circuit (ASIC) to generate a number of P data voltage signals; and
sequentially outputting with the plurality of first switch units a first through a
$$\frac{P}{2} th$$
data voltage signals to the display area, and sequentially outputting with the plurality of second switch units a
$$( \frac{P}{2} + 1 ) th$$
through a Pth data voltage signals to the display area, upon receiving control signals from the plurality of first shift register units and the plurality of second shift register units.

9. A method of claim 8, wherein the display device further comprises a gate driver disposed by a fourth edge of the display area, the fourth edges being opposite to the first edge, the method further comprising:
sequentially outputting with the plurality of first switch units the first through the
$$\frac{P}{2} th$$
data voltage signals to the display area, and sequentially outputting with the plurality of second switch units the
$$( \frac{P}{2} + 1 ) th$$
through the Pth data voltage signals to the display area, upon receiving control signals from the plurality of first shift register units and the plurality of second shift register units, and on generating with the gate driver a plurality of scan signals to the display area.
